(19) United States
(12) Patent Application Publication
(10) Pub. No.: US 2007/0109738 A1
(43) Pub. Date: May 17, 2007

(54) Apparatus for Installation of a Device into a Device Cage

(76) Inventor: Ian Lin, Taipei (TW)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(21) Appl. No.: 11/555,704

(22) Filed: Nov. 2, 2006

(30) Foreign Application Priority Data
Nov. 17, 2005 (TW) 094140446

(51) Int. Cl. G06F 1/16

(52) U.S. Cl. 361/685

(57) ABSTRACT

The present invention discloses a retention apparatus for installation of a device into a device cage, wherein the device cage has a front cage opening and a rear cage opening. The retention apparatus includes: an elongate main body adapted to be positioned on a side of the device; and a latching mechanism mounted on the elongate main body and located corresponding to a location substantially near the rear cage opening for releasably engaging with the device cage. The user can unlatch the latching mechanism near the rear cage opening and move forward the electronic device in combination with the retention apparatus by a finger so that the electronic device in combination with the retention apparatus protrudes from the front cage opening and then the electronic device in combination with the retention apparatus can be removed from the device cage conveniently.

### BACKGROUND OF THE INVENTION

The invention relates to an installation apparatus, and more particularly to a retention apparatus for installation of a device into a device cage.

As technology evolves, for a device to be installed into and removed from a cage in all kinds of products, the trend is toward more rapidness, steadiness, and convenience, so that the user can rapidly and conveniently install a device to a device cage and remove a device from a device cage.

Computer systems (such as personal computers and servers) use various kinds of devices, such as hard disk drive (HDD), floppy disk drive (FDD), and optical disk drive (ODD), and these devices are installed in device cages. Theses device cages are secured in the housing of in the computer system. After the devices are installed in the device cages, the bezel is installed on the housing to cover the front opening of the housing.

The afore-mentioned devices can be installed in the device cages in many ways: one is to use screws to directly fix the device to the device cage, but this method is time-consuming and not convenient either for installation or removal of the devices; the other is to use railing means to install the device into the device cage, and this method is convenient and laborsaving compared to the previous method.

In the conventional ways of installing the device into the device cage, after the device is installed in the cages of the housing, the user has to install the bezel on the housing; and if the user wants to remove the devices from the device cages, the bezel is also to be removed previously. The action of installing and removing the bezel results in extra workload.

Therefore, there is an urgent need for an apparatus for installation of a device into a device cage so that the device can be easily and conveniently installed in the device cage with low-cost and simple structure, and further the device can still be installed into and removed from the device cage of the housing without removing the bezel from the housing.

### SUMMARY OF THE INVENTION

An object of the present invention is to provide an installation apparatus, which can be conveniently install the device into and remove the device from the device cage without removing the bezel of the housing.

Another object of the present invention is to provide an easy-to-use apparatus for installation of a device into a device cage.

Still another object of the present invention is to provide a low-cost apparatus for installation of a device into a device cage.

Yet another object of the present invention is to provide an installation apparatus with simple structure.

A first general aspect of the present invention provides a retention apparatus for installation of a device into a device cage. The device cage has a front cage opening and a rear cage opening. The retention apparatus can comprise: an elongate main body adapted to be positioned on a side of the device; and a latching mechanism mounted on the elongate main body and located corresponding to a location substantially near the rear cage opening for releasably engaging with the device cage.

Preferably, the latching mechanism can be a first hole located corresponding to a location substantially near the rear cage opening of the device cage. The device cage can have an inner surface, and a first protrusion can be formed on the inner surface and located near the rear cage opening and corresponding to the first hole. The first protrusion can releasably engage with the first hole after the device in combination with the retention apparatus is installed into the device cage through the front cage opening.

Preferably, the elongate main body can have a first end; the first end can protrude from the rear cage opening of the device cage after the device in combination with the retention apparatus is installed into the device cage. The elongate main body can be made of resilient material. The resilient material can be stainless steel. The first end can be deformed toward a disengaging direction to allow the first protrusion disengages with the first hole. A user can bend the first end inwardly toward an axis from the front cage opening to the rear cage opening by one of the user's fingers. The user can move forward the device in combination with the retention apparatus by a force toward the front cage opening after the first protrusion disengages with the first hole, so that a part of the device in combination with the retention apparatus protrudes from the front cage opening. The user removes the device in combination with the retention apparatus from the front cage opening by exerting a drawing force on the part.

Preferably, the retention apparatus can further comprise at least one positioning mechanism adapted to position the retention apparatus on the side of the device. The at least one positioning mechanism can be a hook formed on the elongate main body. A second hole can be formed on an outer surface of the device and located corresponding to the hook. The hook can releasably engage with the second hole.

Preferably, the retention apparatus can further comprise a railing mechanism for guiding the device in combination with the retention apparatus into and away from the device cage. The device can be selected from a group comprising FDD, HDD, and ODD.

A second general aspect of the present invention provides a computer system, and the computer system comprises a device; a device cage for encasing the device (the device cage has a front cage opening and a rear cage opening); and a retention apparatus for installing the device into the device cage, the retention apparatus comprising an elongate main body for being positioned on a side of the device; and a latching mechanism mounted on the elongate main body and located corresponding to a location substantially near the rear cage opening for releasably engaging with the device cage.

Preferably, the latching mechanism can be a first hole located corresponding to a location substantially near the rear cage opening of the elongate main body. The device cage can have an inner surface. A first protrusion can be formed on the inner surface and located near the rear cage opening and corresponding to the first hole. The first protrusion can releasably engage with the first hole after the device in combination with the retention apparatus is installed into the device cage through the front cage opening.

Preferably, the elongate main body can have a first end; the first end can protrude from the rear-cage opening of the device cage after the device in combination with the retention apparatus is installed into the device cage. The elongate main body can be made of a resilient material. The first end can be deformed toward a disengaging direction to allow the first protrusion disengages with the first hole. A user can deform the first end inwardly toward an axis from the front cage opening to the rear cage opening by one of the user's fingers. The user can move forward the device in combination with the retention apparatus by a force toward the front cage opening after the first protrusion disengages with the first hole, so that a part of the device in combination with the retention apparatus protrudes from the front cage opening. The user can remove the device in combination with the retention apparatus from the front cage opening by exerting a drawing force on the part.

A third general aspect of the present invention provides a cage system, and the cage system can comprise: a device cage adapted to hold a device, the device cage comprising a front cage opening and a rear cage opening; and a retention apparatus adapted to install the device into the device cage, the retention apparatus comprising an elongate main body adapted to be positioned on a side of the device; and a latching mechanism mounted on the elongate main body and located corresponding to a location substantially near the rear cage opening for releasably engaging with the device cage.

Preferably, the latching mechanism can be a first hole located corresponding to a location substantially near the rear cage opening of the device cage. The device cage can have an inner surface. A first protrusion can be formed on the inner surface and located near the rear cage opening and corresponding to the first hole. The first protrusion can releasably engage with the first hole after the device in combination with the retention apparatus is installed into the device cage through the front cage opening.

Preferably, the elongate main body can have a first end. The first end can protrude from the rear cage opening of the device cage after the device in combination with the retention apparatus is installed into the device cage.

Preferably, the elongate main body can be made of a resilient material. The first end can be deformed toward a disengaging direction to allow the first protrusion disengages with the first hole. A user can bend the first end inwardly toward an axis from the front cage opening to the rear cage opening by one of the user's fingers.

Preferably, the user can move forward the device in combination with the retention apparatus by a force toward the front cage opening after the first protrusion disengages with the first hole, so that a part of the device in combination with the retention apparatus protrudes from the front cage opening. The user can remove the device in combination with the retention apparatus from the front cage opening by exerting a drawing force on the part.

The foregoing and other features of the invention will be apparent from the following more particular description of the embodiments of the invention.

### BRIEF DESCRIPTION OF THE DRAWINGS

The embodiments of this invention will be described in detail, with reference to the following figures, wherein:

FIG. 1 schematically shows a retention apparatus, a device, and a device cage according to one preferred embodiment of the present invention;

FIG. 2 schematically shows a retention apparatus according to one preferred embodiment of the present invention;

FIGS. 3A and 3B schematically show how a device in combination with a retention apparatus is installed into a device cage according to one preferred embodiment of the present invention;

FIGS. 4A and 4B schematically show how a device in combination with an retention apparatus is removed from a device cage according to one preferred embodiment of the present invention; and

FIG. 5 schematically shows variable devices installed in a housing according to one preferred embodiment of the present invention.

### DETAILED DESCRIPTION OF THE INVENTION

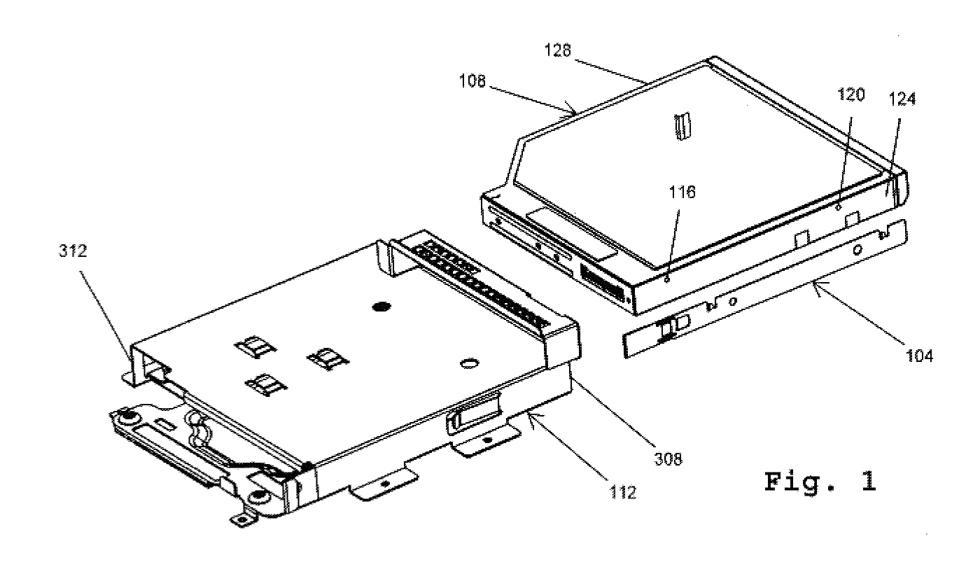

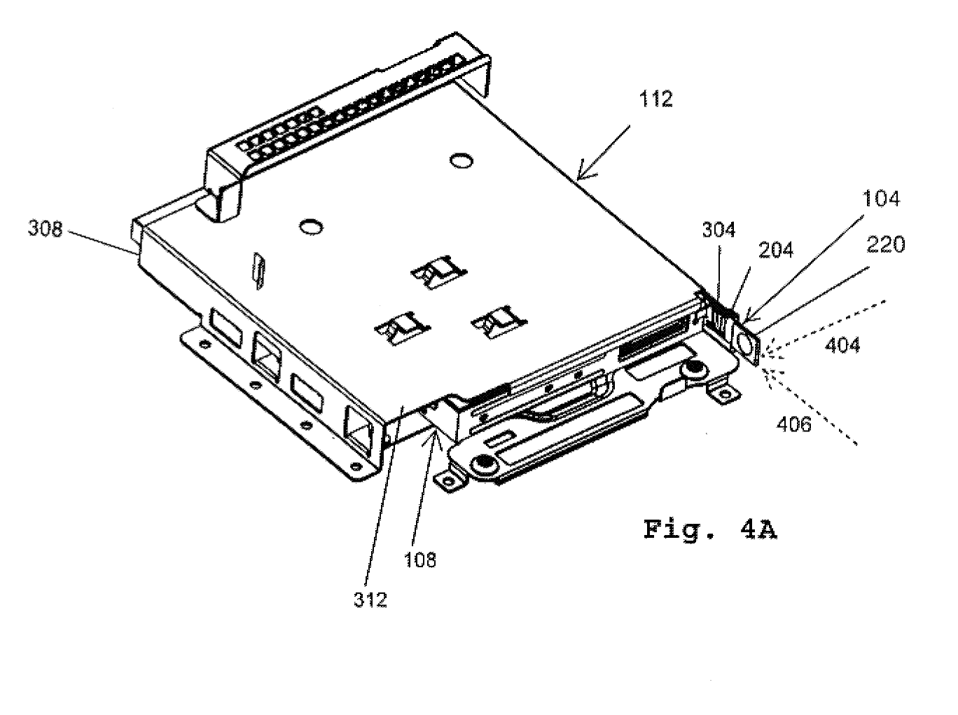

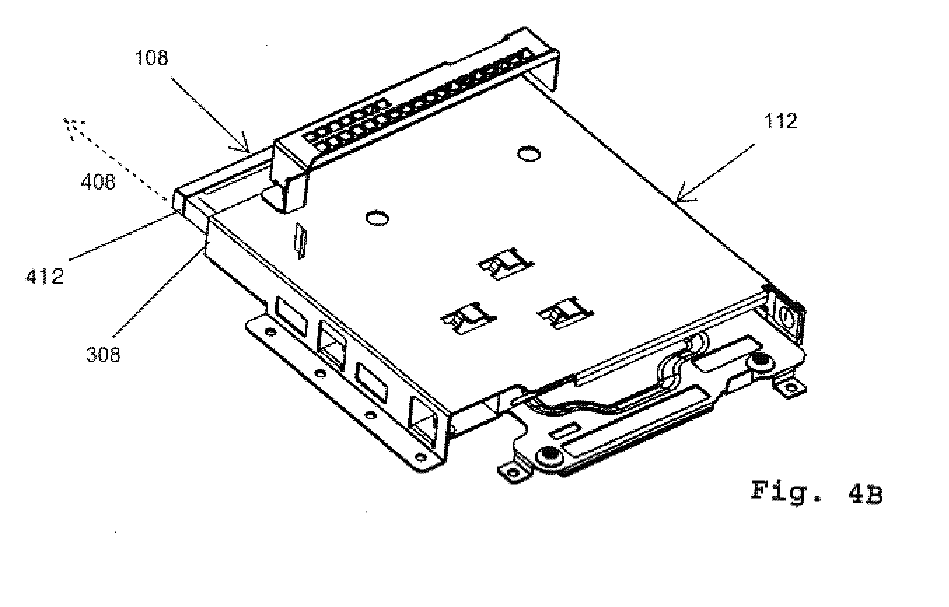

Referring to FIG. 1, it schematically shows an retention apparatus 104, a device 108, and a device cage 112 according to one preferred embodiment of the present invention. The device 108 can be an electrical or an electronic device. Taking the electronic device for example, the electronic device can be a floppy disk drive (FDD), a hard disk drive (HDD), an optical disk drive (ODD), an tape drive, or other devices with device cages. The device cage 112 has a front cage opening 308 and a rear cage opening 312. Please also refer to FIG. 4A, a latching protrusion 304 is formed on the inner surface of the housing 112. The device 108 can be a cuboid with a pair of rectangular sides 124, 128, and there are holes 116, 120 formed on the side 124.

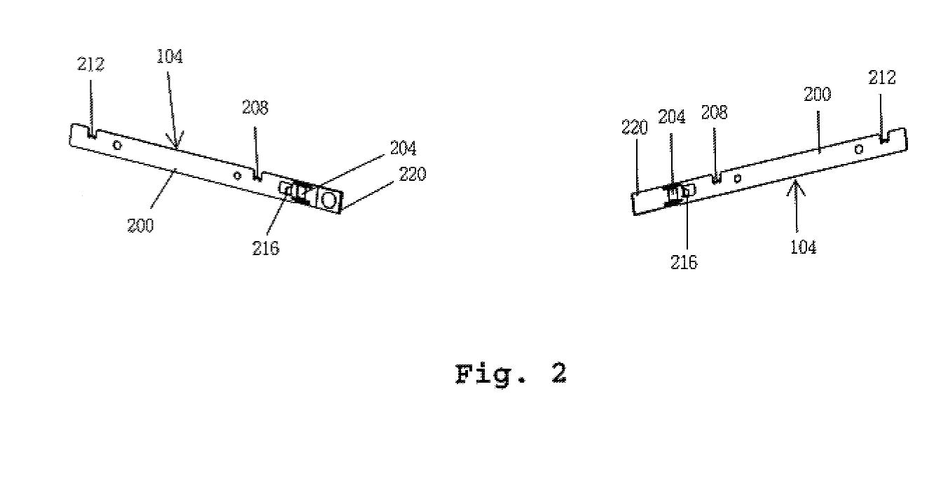

Please refer to FIG. 2, which schematically shows a first side and a second side of a retention apparatus 104 according to one preferred embodiment of the present invention. The retention apparatus 104 for installation of the device 108 into the device cage 112 includes an elongate main body 200, which is made of a resilient material (can be stainless steel or other materials), and with a length of 135 mm, a width of 10 mm, and a thickness of 0.6 mm, and a latching mechanism 204 mounted on the elongate main body 200 and located substantially corresponding to a location near the rear cage opening 312. The latching mechanism 204 is used for latching the device 108 in combination with the retention apparatus 104 in the device cage. In one preferred embodiment, the latching mechanism 204 is an engaging hole. It is noted that the engaging hole 204 is located on a location of the elongate main body 200, and this location is substantially near the rear cage opening 312 and far away from the front the rear cage opening 308.

The retention apparatus 104 further includes a positioning mechanism 208, 212 for positioning and fixing the retention apparatus 104 on the sides 124 of the device 108. In one preferred embodiment, the positioning mechanism 208, 212 can respectively be a hook, which is respectively engaged with the hole 116, 120 of the device 108. The retention apparatus 104 also includes a secondary positioning mechanism 216 for assisting in positioning and fixing the retention apparatus 104 on the device 108 while the hooks 208, 212 respectively engaging with the hole 116, 120. In one preferred embodiment, the secondary positioning mechanism 216 can be a tab, which engages with the device 108 while the hooks 208, 212 respectively engaging with the hole 116, 120.

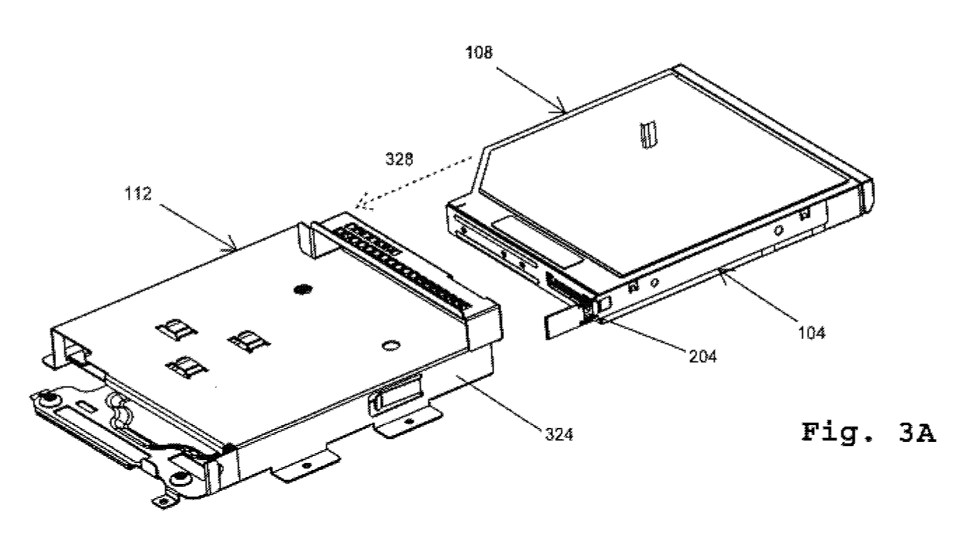

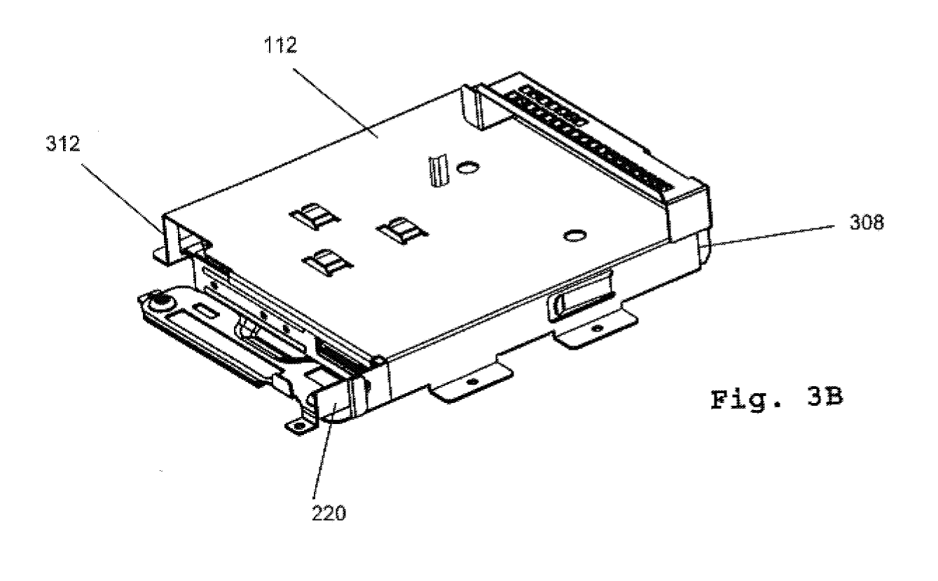

FIGS. 3A and 3B schematically show how a device 108 in combination with an retention apparatus 104 is installed into a device cage 112 according to one preferred embodiment of the present invention. As mentioned earlier, the latching protrusion 304 is formed on the inner surface of the device cage 112 (FIG. 4A). It is noted that the location of the latching protrusion 304 is corresponding to the location of the engaging hole 204 of the retention apparatus 104, as shown in FIG. 3A. After the device 108 in combination with the retention apparatus 104 is inserted into the device cage 112 (the inserting direction is indicated by an arrow 328), the engaging hole 204 and the latching protrusion 304 are engaged so that the device 108 in combination with the retention apparatus 104 is installed in the device cage 112.

FIG. 3B schematically shows a view after the device 108 in combination with an retention apparatus 104 is installed into a device cage 112 according to one preferred embodiment of the present invention. The elongate main body 200 of the retention apparatus 104 has a first end 220; and as shown in FIG. 3B, after the device 108 in combination with the retention apparatus 104 is inserted and installed in the device cage 112, the first end 220 protrudes from the rear cage opening 312 of the device cage 112. Referring again to FIG. 3A, on the other hand, on the inner surface of one side 324 of the device cage (corresponding to the side 124 of the device 108), a railing mechanism (not shown) is formed for smoothly guiding the device 108 in combination with the retention apparatus 104 into and away from the device cage 112.

Please refer to FIGS. 4A and 4B, which schematically show how a device 108 in combination with an retention apparatus 104 is removed from a device cage 112 according to one preferred embodiment of the present invention. As described before, the device 108 in combination with the retention apparatus 104 is securely installed in the device cage 112, after the engaging hole 204 and the latching protrusion 304 are firmly engaged. As shown in FIG. 4A, the user can use one finger to exert a force on the first end 220 (which protrudes from the rear cage opening 312 of the device cage 112 after the device 108 in combination with the retention apparatus 104 is inserted and installed in the device cage 112) so that the first end 220 is deformed toward a disengaging direction and thus the latching protrusion 304 disengages with the engaging hole 204. The direction 404 of the exerting force on the first end 220 can be inwardly toward an axis from said the rear cage opening 312 to the front cage opening 308. By the force of the direction 404, the latching protrusion 304 disengages with the engaging hole 204. After disengagement of the latching protrusion 304 and the engaging hole 204, the user can then use one finger to exert a force to move the device 108 in combination with the retention apparatus 104. The direction 406 of the exerting force on the first end 220 can be toward the front cage opening 308. After the user move the device 108 in combination with the retention apparatus 104 by a force of the direction 406, a part 412 of the device 108 in combination with the retention apparatus 104 will protrude from the front cage opening 308 as shown in FIG. 4B). Therefore, the user can hold the part 412 protruding from the front cage opening 308 and remove the device 108 in combination with the retention apparatus 104 from the front cage opening 308 (the removing direction is indicated by arrow 408 in FIG. 4B).

It can be understood that the present invention provides many advantages: simpler structure, lower cost, and easier way of use. The user can only use one finger to bend the first end 220 of the elongate main body 200 (the rear opening of the housing is not sealed and a gap or an opening is reserved to allow the user to put his fingers therein, and the user can therefore bend the first end, which is located corresponding the rear cage opening 312). The engaging hole 204 and the latching protrusion 304 are then disengaged. Since the action of disengagement is done in the rear part of the housing corresponding to the rear cage opening 312, after disengagement of the latching protrusion 304 and the engaging hole 204, the user can use the same finger to exert a force of the direction 406 on the first end 220 to move forward the device 108 in combination with the retention apparatus 104 to allow the part 412 to protrude from the front cage opening 308. Finally, the user hold the protruding part 412 and remove the device 108 in combination with the retention apparatus 104 from the front cage opening 308 with a drawing force of the direction 408.

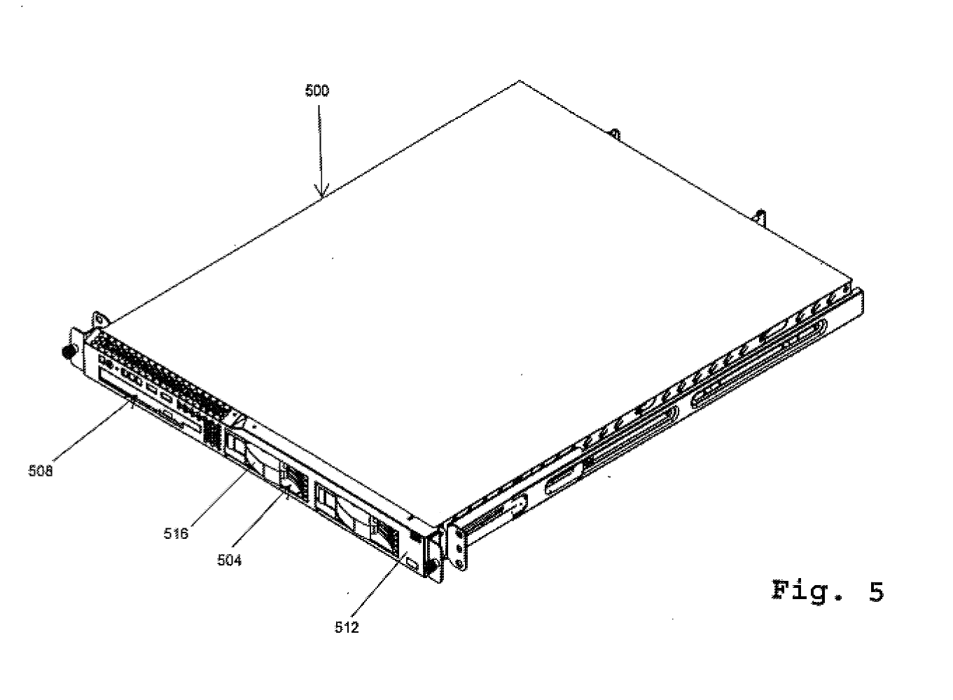

FIG. 5 schematically depicts a preferred embodiment of the present invention, wherein variable devices are installed in a housing 500. There are several device cages in the housing 500, and the device cages are used for encaging various devices. In FIG. 5, two kinds of devices are shown: hot swap hard disk drives 504 and optical disk drives 508 (the optical disk drives can alternatively be floppy disk drives, hard disk drives, or tapes drives). A bezel 512 is also shown in FIG. 5. In this embodiment, the bezel 512 is fixedly manufactured on the housing 500, and the bezel 512 cannot be removed from the housing 500.

A hot swap carrier handler 516 is usually used on the hot swap disk drive 504 for a hot swap operation, so that the user can directly exert a force on the handler 516 and thus the hard swap disk drive 504 can be removed from the cage or installed on the cage.

Compared to the hard swap disk drive, the optical disk drive is seldom removed from and installed on the cage after the optical disk drive has been installed on the cage, and the complicated and expensive hard swap carrier handler is seldom used on the optical disk drive (because there is no need for a hard swap operation). Therefore in the conventional technology, for removing the optical disk drive from the cage or installing the optical disk drive to the cage, the bezel has to be removed from the housing previously, which results in inconvenience and complicated and difficult installation.

On the contrary, the preferred embodiment in FIG. 5 solves the above problems. The bezel 512 is fixedly manufactured on the housing 500. The hot swap disk drive 504 uses the hot swap carrier handler to achieve the installation/remove purpose. The optical disk drive 508 is installed in the housing and without the need of removing the bezel 512 by the present invention. For the installing operation of the optical disk drive 508, the user only inserts the device 108 in combination with the retention apparatus 104 into the front cage opening 308 and engaging them on the device cage 112. For the removing operation of the optical disk drive 508, the user only use one finger to bend the first end 220 (corresponding to the rear cage opening 312) of the retention apparatus 104 toward the direction 404, and then use the same finger to move forward the device 108 in combination with the retention apparatus 104 toward the direction 406 to allow the device 108 in combination with the retention apparatus 104 to protrude from the front cage opening 308, and then the user can hold the protruding part 412 of the device 108 in combination with the retention apparatus 104 and remove them from the front cage opening 308 with a drawing force of the direction 408.

With reference to FIGS. 1-5, because the latching mechanism 204 is located substantially corresponding to a location near the rear cage opening 312, the unlatching and disengaging operation is achieved substantially near said rear cage opening 312. After the user unlatches the latching protrusion 304 and the engaging hole 204 and moves forward the device 108 in combination with the retention apparatus 104 to allow the part 412 protrude from the front cage opening 308, and then the device 108 in combination with the retention apparatus 104 is removed from the front cage opening 308. It's apparent that there is no need to remove the bezel 512 from the housing 500 if the device 108 is to be installed in the device case 112 or removed from the device case 112.

While this invention has been described in conjunction with the specific embodiments outlined above, it is evident that many alternatives, modifications and variations will be apparent to those skilled in the art. For example, the resilient material of the elongate main body is not limited to a stainless steel material, but can be other resilient materials, such as a plastic material; the installed devices are not limited to electrical/electronic devices, but can be all kinds of devices; the bezel can be fixedly manufactured on the housing or can be designed to be removable from the housing. Accordingly, the embodiments of the invention as set forth above are intended to be illustrative, not limiting. Various changes may be made without departing from the spirit and scope of the invention as defined in the following claims.

What is claimed is:

1. A retention apparatus for installation of a device into a device cage, said device cage having a front cage opening and a rear cage opening, comprising:
an elongate main body adapted to be positioned on a side of said device; and
a latching mechanism mounted on said elongate main body and located corresponding to a location substantially near said rear cage opening for releasably engaging with said device cage.

2. The retention apparatus of claim 1, wherein said latching mechanism is a first hole located corresponding to a location substantially near said rear cage opening of said cage device.

3. The retention apparatus of claim 2, wherein said device cage has an inner surface, and a first protrusion is formed on said inner surface, located near said rear cage opening, and corresponding to said first hole, wherein said first protrusion releasably engages with said first hole after said device in combination with said retention apparatus is installed into said device cage through said front cage opening, wherein said elongate main body has a first end; and said first end protrudes from said rear cage opening of said device cage after said device in combination with said retention apparatus is installed into said device cage.

4. The retention apparatus of claim 3, wherein said first end is deformed toward a disengaging direction to allow said first protrusion disengage with said first hole.

5. The retention apparatus of claim 1, further comprising at least one positioning mechanism adapted to position said retention apparatus on said side of said device.

6. The retention apparatus of claim 5, wherein said at least one positioning mechanism is a hook formed on said elongate main body, wherein a second hole is formed on an outer surface of said device and located corresponding to said book, wherein said hook releasably engages with said second hole.

7. The retention apparatus of claim 6, further comprising a railing mechanism for guiding said device in combination with said retention apparatus into and away from said device cage.

8. The retention apparatus of claim 1, wherein said device is selected from a group comprising FDD, HDD, and ODD.

9. A computer system, comprising:
a device;
a device cage for encaging said device, said device cage having a front cage opening and a rear cage opening; and
a retention apparatus for installing said device into said device cage, said retention apparatus comprising
an elongate main body for being positioned on a side of said device; and
a latching mechanism mounted on said elongate main body and located corresponding to a location substantially near said rear cage opening for releasably engaging with said device cage.

10. The computer system of claim 9, wherein said latching mechanism is a first hole located corresponding to a location substantially near said rear cage opening of said device cage.

11. The computer system of claim 10, wherein said device cage has an inner surface, and a first protrusion is formed on said inner surface, located near said rear cage opening, and corresponding to said first hole, wherein said first protrusion releasably engages with said first hole after said device in combination with said retention apparatus is installed into said device cage through said front cage opening, wherein said elongate main body has a first end; and said first end protrudes from said rear cage opening of said device cage after said device in combination with said retention apparatus is installed into said device cage.

12. The computer system of claim 11, wherein said first end is deformed toward a disengaging direction to allow said first protrusion disengages with said first hole to disengage said first protrusion from said first hole.

13. The computer system of claim 12, wherein a user bends said first end inwardly toward an axis from said front cage opening to said rear cage opening by one of the user's fingers to disengage said first protrusion from said first hole.

14. The computer system of claim 13, wherein said user moves forward said device in combination with said retention apparatus by a force toward said front cage opening after said first protrusion disengages with said first hole, so that a part of said device in combination with said retention apparatus protrudes from said front cage opening; and said user removes said device in combination with said retention apparatus from said front cage opening by exerting a drawing force on said part.

15. The computer system of claim 9, further comprising at least one positioning mechanism for positioning said retention apparatus on said side of said device.

16. A cage system, comprising:
a device cage adapted to encase a device, said device cage having a front cage opening and a rear cage opening; and
a retention apparatus adapted to install said device into said device cage, said retention apparatus comprising:
an elongate main body adapted to be positioned on a side of said device; and
a latching mechanism mounted on said elongate main body and located corresponding to a location substantially near said rear cage opening for releasably engaging with said device cage.

17. The cage system of claim 16, wherein said latching mechanism is a first hole located corresponding to a location substantially near said rear cage opening of said device cage; wherein said device cage has an inner surface, and a first protrusion is formed on said inner surface and located substantially near said rear cage opening and corresponding to said first hole; and wherein said first protrusion releasably engages with said first hole after said device in combination with said retention apparatus is installed into said device cage through said front cage opening.

18. The cage system of claim 17, wherein said elongate main body has a first end, and said first end protrudes from said rear cage opening of said device cage after said device in combination with said retention apparatus is installed into said device cage.

19. The cage system of claim 18, wherein said elongate main body is made of a resilient material; wherein said first end is deformed toward a disengaging direction to allow said first protrusion disengage with said first hole; and wherein a user bends said first end inwardly toward an axis from said front cage opening to said rear cage opening by one of the user's fingers.

20. The cage system of claim 19, wherein said user moves forward said device in combination with said retention apparatus by a force toward said front cage opening after said first protrusion disengages with said first hole, so that a part of said device in combination with said retention apparatus protrudes from said front cage opening; and wherein said user removes said device in combination with said retention apparatus from said front cage opening by exerting a drawing force on said part.
